(19) United States
(12) Patent Application Publication
(10) Pub. No.: US 2024/0086702 A1
(43) Pub. Date: Mar. 14, 2024

(54) LEARNING DEVICE

(71) Applicant: NEC Corporation, Tokyo (JP)

(72) Inventor: Batnyam Enkhtaivan, Tokyo (JP)

(73) Assignee: NEC Corporation, Tokyo (JP)

(21) Appl. No.: 18/241,611

(22) Filed: Sep. 1, 2023

(30) Foreign Application Priority Data
Sep. 8, 2022 (JP) 2022-143003

(51) Int. Cl. G06N 3/08

(52) U.S. Cl. CPC G06N 3/08

(57) ABSTRACT

A learning device includes an acquisition unit and a conversion unit. The acquisition unit inputs thereto, for each class, an output of a learner for each class received from another learning device and an output of a learner for each class trained by the own device, and acquires a given output for each class. The conversion unit performs, for each class, a conversion process to express a probability with respect to the given output for each class acquired by the acquisition unit.

### INCORPORATION BY REFERENCE

The present invention is based upon and claims the benefit of priority from Japanese patent application No. 2022-143003, filed on Sep. 8, 2022, the disclosure of which is incorporated herein in its entirety by reference.

### TECHNICAL FIELD

The present invention relates to a learning device, a learning method, and a storage medium.

### BACKGROUND ART

In order to achieve better performance, there is a case where learners having learned by the respective participants are combined.

For example, Non-Patent Literature 1 describes art called Gradient Boosting Forest (GBF) in which each participant creates a decision tree in each round and the created decision trees are combined to create a model having better performance.

Further, as a related literature, Patent Literature 1 has been known for example. Patent Literature 1 describes Gradient Boosting Decision Tree (GBDT) in which an additional tree is trained to fill the gap with an existing model and the trained decision tree is combined to improve the accuracy.

Patent Literature 1: JP 2021-140296 A

Non-Patent Literature 1: Feng Wang et al., Gradient Boosting Forest: a Two-Stage Ensemble Method Enabling Federated Learning of GBDTs, ICONIP 2021: Neural Information Processing pp. 75-86

[Searched on Mar. 8, 2022], Internet

<https://link.springer.com/chapter/10.1007/978-3-030-92270-2_7>

### SUMMARY

According to Non-Patent Literature 1, in the case of performing GBF for multi-class classification, after softmax conversion is performed on an output of each decision tree, a value after the conversion is added to the result up to the previous round at a predetermined ratio. In the softmax conversion, conversion is performed in such a manner that an output with respect to an input falls within a range from 0 to 1. As a result, only a positive value is added in each round, and even if an increase in the probability of an incorrect class is overestimated in any round, it is difficult to correct it. As described above, there is a case where precise learning is difficult in the GBF.

In view of the above, an exemplary object of the present invention is to provide a learning device, a learning method, a storage medium, and the like capable of solving the above-described problem.

In order to achieve such an object, a learning device according to one aspect of the present disclosure is configured to include
an acquisition unit that inputs thereto, for each class, an output of a learner for each class received from another learning device and an output of a learner for each class trained by
an own device, and acquires a given output for each class, and a conversion unit that performs, for each class, a conversion process to express a probability with respect to the output for each class acquired by the acquisition unit.

Further, a learning method according to another aspect of the present disclosure is configured to include, by an information processing device,
inputting, for each class, an output of a learner for each class received from another learning device and an output of a learner for each class trained by the own device, and acquiring a given output for each class; and
performing, for each class, a conversion process to express a probability with respect to the acquired output for each class.

Further, a storage medium according to another aspect of the present disclosure is a computer-readable medium storing thereon a program for causing an information processing device to execute processing to:
input, for each class, an output of a learner for each class received from another learning device and an output of a learner for each class trained by the own device, and acquire a given output for each class; and
perform, for each class, a conversion process to express a probability with respect to the acquired output for each class.

With the configurations described above, the problem described above can be solved.

### BRIEF DESCRIPTION OF DRAWINGS

FIG. 1 is a diagram for explaining the outline of the present disclosure.

FIG. 2 illustrates an example of a state of a model in the mil′ round.

FIG. 3 illustrates an exemplary configuration of a learning system according to a first example embodiment of the present disclosure.

FIG. 4 is a block diagram illustrating an exemplary configuration of a learning device.

FIG. 5 illustrates an example of learning data information.

FIG. 6 is a flowchart illustrating an exemplary operation of a learning device.

FIG. 7 is a block diagram illustrating an exemplary configuration of a learning device according to a second example embodiment of the present disclosure.

FIG. 8 illustrates an example of softmax conversion.

FIG. 9 illustrates an exemplary configuration of a neural network.

FIG. 10 illustrates an exemplary hardware configuration of a learning device according to a third example embodiment of the present disclosure.

FIG. 11 is a block diagram illustrating an exemplary configuration of a learning device.

### EXAMPLE EMBODIMENTS

### First Example Embodiment

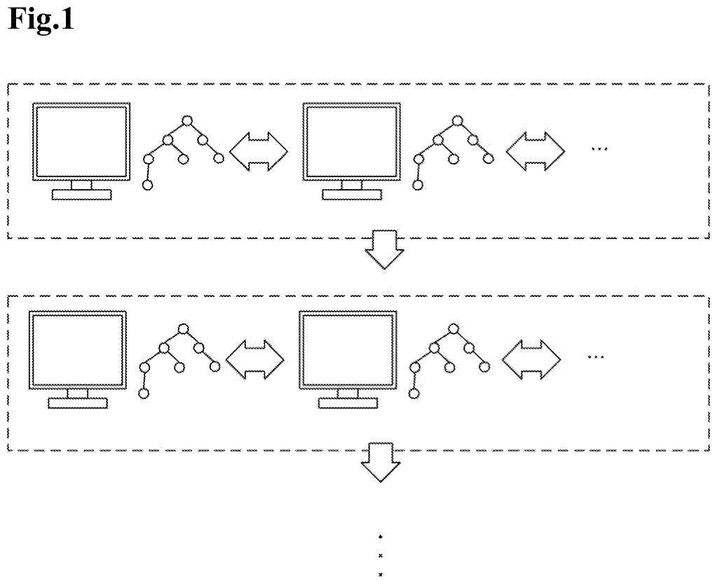

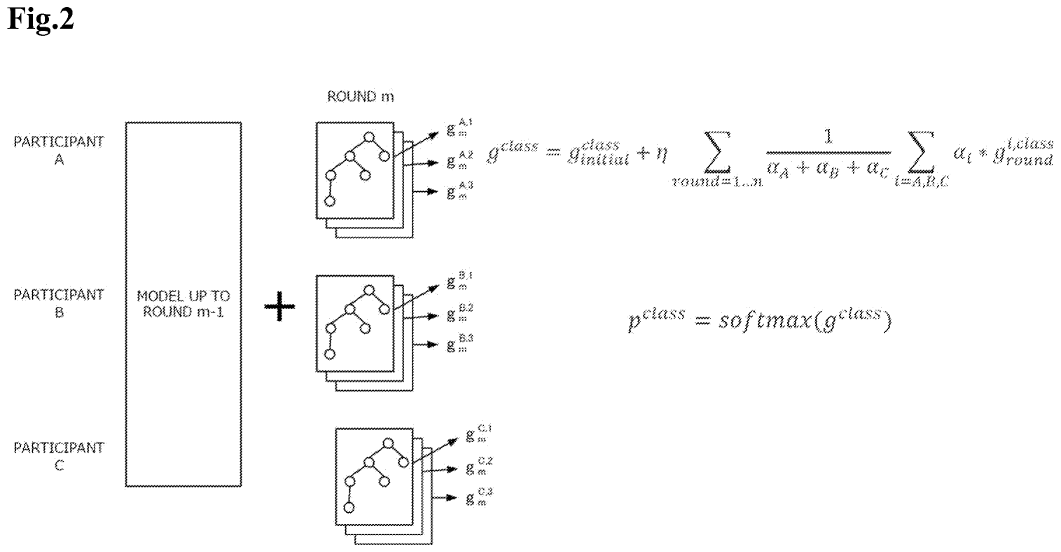

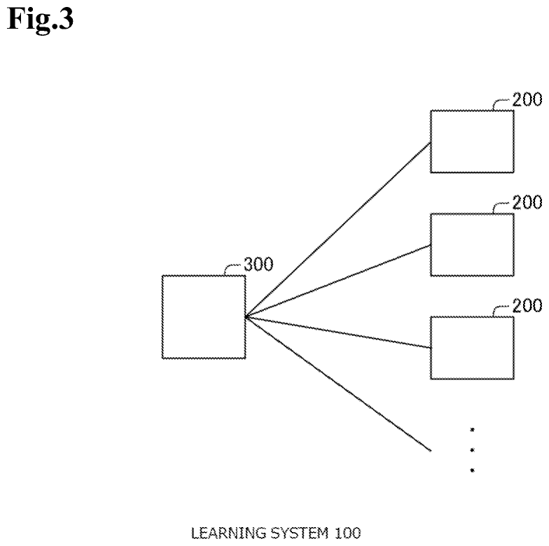

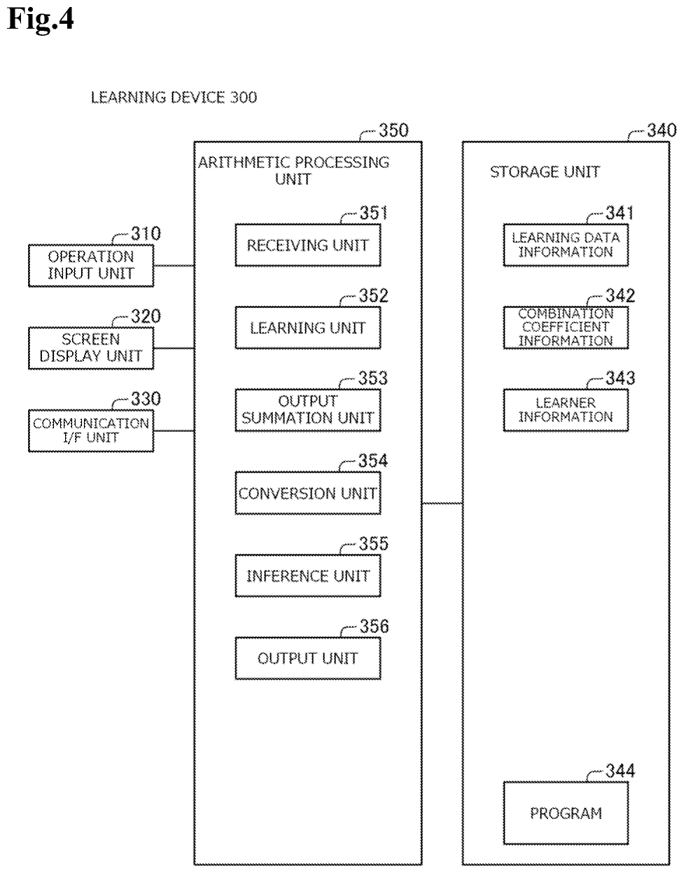

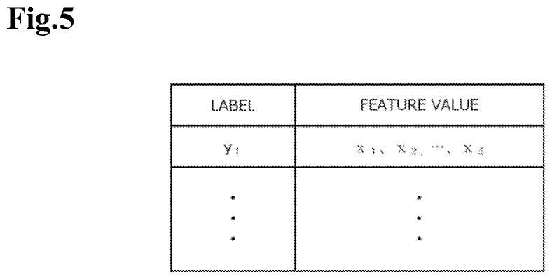

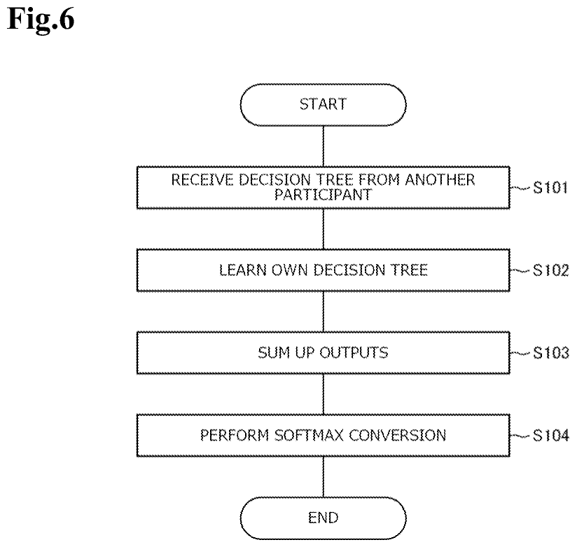

A first example embodiment of the present disclosure will be described with reference to FIGS. 1 to 6. FIG. 1 is a diagram for explaining the outline of the present disclosure. FIG. 2 illustrates an example of a state of a model in the m^{th} round. FIG. 3 illustrates an exemplary configuration of a learning system 100. FIG. 4 is a block diagram illustrating an exemplary configuration of a learning device 300. FIG. 5 illustrates an example of learning data information 341. FIG. 6 is a flowchart illustrating an exemplary operation of the learning device 300.

In the first example embodiment of the present disclosure, as illustrated in FIG. 1, a learning system 100 for multi-class classification to create a model having a better performance by combining decision trees trained by the respective participants in each round will be described. As described below, in the learning system 100 of the present embodiment, each participant trains a decision tree corresponding to each class that is a classification object in each round. Then, the learning system 100 combines the decision tress trained by the respective participants. At that time, the learning system 100 of the present embodiment adds outputs of the decision trees trained by the respective participants at a predetermined ratio. Then, the learning system 100 performs a conversion process to express a probability such as softmax conversion. As a result, the learning system 100 can perform precise learning.

For example, FIG. 2 illustrates an example of a state of a model in the m^{th} round. In FIG. 2, an output of a decision tree with respect to data is represented by g^{class}. As an example, g^{A,3} represents an output of a decision tree corresponding to a class 3 trained by a participant A. As illustrated in FIG. 2, in the learning system 100 described in the present embodiment, outputs of the m^{th} round are added to the output of the model up to the (m−1)^{th} round with use of a combination coefficient α to be described below. At that time, the learning system 100 may perform the addition process for each class. Then, the learning system 100 performs a conversion process to express a probability such as softmax conversion. As described above, the learning system 100 in the present embodiment is configured to perform a conversion process for expressing the probability after adding the outputs.

In the present embodiment, a conversion process for expressing a probability means a conversion process performed such that the total value of the outputs takes a predetermined value such as 1 and a score that is an output to be classified to each class takes a positive value. For example, a conversion process to express a probability may be softmax conversion or the like. A conversion process to express a probability may be one other than that illustrated above in which the total value of the outputs takes a predetermined value such as 1 and a score to be classified to each class takes a positive value. For example, it is assumed that an output of a decision tree corresponding to class 1 with respect to data is a1, an output of a decision tree corresponding to class 2 is a2, and an output of a decision tree corresponding to class 3 is a3. In this case, as a conversion process to express a probability, the learning system 100 may perform a process of dividing the value of a1 by the total output value of the respective classes such as a1+a2+a3 in the decision tree corresponding to class 1. As a conversion process to express a probability, the learning system 100 may perform a process other than that illustrated above, such as calculating a1²/(a1²+a2²+a3²) in which the absolute value of the score is divided by the sum of the absolute values corresponding to the respective classes.

Hereinafter, the configuration of the learning system 100 in the present embodiment will be described in more detail. FIG. 3 illustrates an overall exemplary configuration of the learning system 100. Referring to FIG. 3, the learning system 100 includes one or more other learning devices 200 and a learning device 300. As illustrated in FIG. 3, each of the other learning devices 200 and the learning device 300 are connected communicably with each other over a network or the like. Note that the learning system 100 may include a plurality of learning devices 300, or may be configured of a plurality of learning devices 300 without any other learning devices 200.

The other learning device 200 is an information processing device that generates a decision tree that is a learner, by performing training based on learning data held by the other learning device 200. As described above, the other learning device 200 in the present embodiment can train the decision tree for each class that is a classification object in each round. Note that the other learning device 200 may train a decision tree by a general method such as GBDT described in Patent Literature 1. The other learning device 200 can transmit a generated decision tree to another learning device 200 and the learning device 300.

The learning device 300 is an information processing device that creates a model having a better performance by combining decision trees trained by the respective participants such as the other learning device 200 and the learning device 300 in respective rounds. As described above, the learning device 300 described in the present embodiment can combine the respective decision trees by performing a conversion process for expressing a probability such as softmax conversion, after adding the outputs of the decision tress at a predetermined ratio. FIG. 4 illustrates an exemplary configuration of the learning device 300. Referring to FIG. 4, the learning device 300 includes, for example, an operation input unit 310, a screen display unit 320, a communication OF unit 330, a storage unit 340, and an arithmetic processing unit 350, as main constituent elements.

FIG. 4 illustrates the case of implementing the function as the learning device 300 by using one information processing device, as an example. However, the learning device 300 may be implemented by using a plurality of information processing devices such as implemented on the cloud, for example. Moreover, the learning device 300 may not include part of the above-mentioned constituent elements such as not including the operation input unit 310 or the screen display unit 320, or may include a constituent element other than those described above.

The operation input unit 310 is configured of operation input devices such as a keyboard and a mouse. The operation input unit 310 detects operation by an operator who operates the learning device 300, and outputs it to the arithmetic processing unit 350.

The screen display unit 320 is configured of a screen display device such as a liquid crystal display (LCD). The screen display unit 320 can display, on the screen, various types of information stored in the storage unit 340, in response to an instruction from the arithmetic processing unit 350.

The communication OF unit 330 is configured of a data communication circuit. The communication OF unit 330 performs data communication with an external device connected over a communication network.

The storage unit 340 is a storage device such as a hard disk or a memory. The storage unit 340 stores therein processing information and a program 344 required for various types of processing performed in the arithmetic processing unit 350. The program 344 is read and executed by the arithmetic processing unit 350 to thereby implement various processing units. The program 344 is read in advance from an external device or a storage medium via a data input/output function of the communication I/F unit 330 or the like, and is stored in the storage unit 340. The main information stored in the storage unit 340 includes, for example, learning data information 341, combination coefficient information 342, learner information 343, and the like.

The learning data information 341 includes learning data to be used for training of a decision tree that is a learner. For example, the learning data information 341 is acquired in advance by using a method of acquiring it from an external device via the communication I/F unit 330, inputting it using the operation input unit 310, or the like, and is stored in the storage unit 340.

FIG. 5 illustrates an example of the learning data information 341. Referring to FIG. 5, in the learning data information 341, a plurality of feature values and labels corresponding to classes that are classification objects are associated with each other. For example, in the example illustrated in FIG. 5, feature values (x₁, x₂, . . . , x_{d}) and a label y₁ are associated with each other. As illustrated in FIG. 5, the learning data information 341 may include a plurality of learning datasets.

The combination coefficient information 342 includes information about a combination coefficient to be used for adding outputs of decision trees that are learners trained by the respective participants at a predetermined ratio. The combination coefficient information 342 may include a combination coefficient for each of the participants such as the other learning devices 200 and the learning device 300. For example, the combination coefficient information 342 is acquired in advance by using a method of acquiring it from an external device via the communication OF unit 330, inputting it by using the operation input unit 310, or the like, and is stored in the storage unit 340.

For example, a combination coefficient is determined previously based on the number of learning datasets held by the respective participants such as the other learning devices 200 and the learning device 300, as described in Non-Patent Literature 1. As an example, a combination coefficient to be used for combining a decision tree learned by a participant is calculated previously by dividing the number of pieces of learning data held by the participant by the sum of the numbers of the pieces of learning data held by all participants such as the other learning devices 200 and the learning device 300. Note that the combination coefficient may be calculated and determined previously by a known method other than that illustrated above.

The learner information 343 includes information about the decision trees trained or combined by the other learning devices 200 and the learning device 300 such as the own device. For example, in the learner information 343, identification information indicating the transmission source of a decision tree and the decision tree may be associated with each other. Moreover, the learner information 343 may include a decision tree for each round and each class. For example, the learner information 343 is updated in response to reception of a decision tree by a receiving unit 351, to be described below, from the other learning device 200 or the like, training of a decision tree by a learning unit 352, combination of a decision tree by an output summation unit 353 and a conversion unit 354, and the like.

The arithmetic processing unit 350 includes an arithmetic unit such as a central processing unit (CPU) and the peripheral circuits thereof. The arithmetic processing unit 350 reads, from the storage unit 340, and executes the program 344 to implement various processing units through cooperation between the hardware and the program 344. Main processing units to be implemented by the arithmetic processing unit 350 include, for example, the receiving unit 351, the learning unit 352, the output summation unit 353, the conversion unit 354, an inference unit 355, an output unit 356, and the like.

Note that the arithmetic processing unit 350 may include a Graphic Processing Unit (GPU), a Digital Signal Processor (DSP), an Micro Processing Unit (MPU), an Floating point number Processing Unit (FPU), a Physics Processing Unit (PPU), a Tensor Processing Unit (TPU), a quantum processor, a microcontroller, or a combination thereof, instead of the CPU.

The receiving unit 351 receives a decision tree that is a learner from each of the other learning devices 200 and another learning device 300. For example, the receiving unit 351 can receive a decision tree for each class from each of the other learning devices 200 and the like included in the learning system 100. Moreover, the receiving unit 351 stores the received decision tree in the storage unit 340 as the learner information 343.

Note that the receiving unit 351 may receive information indicating the difference from the decision tree in the previous round or the like from the other learning device 200 or the like, for example. In that case, the receiving unit 351 may be configured to update the corresponding decision tree on the basis of the received information indicating the difference.

The learning unit 352 performs learning based on the learning data represented by the learning data information 341 to train the decision tree that is a learner. The learning unit 352 may train the decision tree for each class. For example, the learning unit 352 can train an additional decision tree so as to correct the error in the model up to the previous round by using a method such as GBDT described in Patent Literature 1. The learning unit 352 may train the decision tree by using another known method. Moreover, the learning unit 352 stores the trained decision tree in the storage unit 340 as the learner information 343.

The output summation unit 353 functions as an acquisition unit that inputs thereto, for each class, an output of a decision tree that is a learner received from another learning device and an output of a decision tree that is a learner trained by the own device, and acquires a given output for each class. For example, the output summation unit 353 adds up outputs of the decision trees trained by the respective participants such as the other learning devices 200 and the learning device 300 to acquire the given output. As an example, the output summation unit 353 adds the output of the decision tree trained in the current round to the output of the model up to the previous round by using a combination coefficient α that is a weight previously calculated based on the learning data held by the respective participants and is stored as the combination coefficient information 342. The output summation unit 353 may perform the weighted addition process for each class.

For example, the output summation unit 353 performs computation using Expression 1 to perform the weighted addition process as described above for each class. Expression 1 shows an example of a process in which the participants are A, B, and C. For example, as shown by Expression 1, the output summation unit 353 can add the output of the decision tree trained in the current round to the output of the model up to the previous round, by using the combination coefficient α for each participant, for each class.

$${g}^{class} = {g}_{initial}^{class} + η {\sum }_{round = 1 … n} \frac{1}{{α}_{A} + {α}_{B} + {α}_{C}} {\sum }_{i = A , B , C} {α}_{i} * {g}_{round}^{i , class} \qquad [ Expression 1 ]$$

Note that g represents an output of a decision tree, and gᵢₙᵢₜᵢₐₗ represents an output of a model up to the previous round. For example, g^{i,class} represents an output of a decision tree corresponding to a class trained by a participant i. a represents a combination coefficient. For example, as represents a combination coefficient corresponding to the participant A.

The conversion unit 354 uses a result of the processing by the output summation unit 353 to perform a conversion process for expressing a probability for each class. The conversion unit 354 stores the conversion result in the storage unit 340 as the learner information 343.

For example, as a conversion process for expressing a probability, the conversion unit 354 performs softmax conversion as shown by Expression 2. Here, softmax conversion has characteristics in which the output total becomes 1 and the output falls within a range from 0 to 1 with respect to any input. Moreover, the softmax conversion has characteristics to keep the magnitude relationship. That is, when the conversion object has a relationship of g¹>g², P that is a value after conversion also has a relationship of P¹>P².

$$\begin{matrix}{y}_{i} = \frac{{e}^{{x}_{i}}}{{\sum }_{k = 1}^{n} {e}^{{x}_{k}}} & ( i = 1 , 2 , … , n )\end{matrix} \qquad [ Expression 2 ]$$

Note that in Expression 2, y represents a value p indicating the probability output as a conversion result, and x corresponds to an output g of the decision tree on which the output summation unit 353 performs the processing. Moreover, i represents a value according to the participants such as the other learning device 200 and the learning device 300. In Expression 2, n represents the number of participants included in the learning system 100, and may take any value.

The inference unit 355 performs inference using the conversion result by the conversion unit 354. For example, the inference unit 355 may perform inference also using the decision tree trained in the past round and the combination coefficient.

The output unit 356 performs output of a decision tree included in the storage unit 340 and output of an inference result by the inference unit 355. For example, the output unit 356 may transmit a decision tree to an external device such as the other learning device 200 via the communication I/F unit 330, or display an inference result on the screen display unit 320 or transmit it to an external device via the communication IN unit 330. The output unit 356 can perform output at any timing.

The exemplary configuration of the learning device 300 is as described above. Next, an exemplary operation of the learning device 300 will be described with reference to FIG. 6. FIG. 6 is a flowchart illustrating an exemplary operation of the learning device 300 in a round. Referring to FIG. 6, the receiving unit 351 receives a decision tree that is a learner from another learning device 200 (step S101). The receiving unit 351 may receive a decision tree for each class that is a classification object.

The learning unit 352 performs learning based on the learning data represented by the learning data information 341 to generate a decision tree that is a learner (step S102). For example, the learning unit 352 generates an additional decision tree so as to correct the error in the model up to the previous round by using a method such as GBDT described in Patent Literature 1. The learning unit 352 may generate a decision tree for each class.

The output summation unit 353 adds up outputs of the decision trees trained by the respective participants such as the other learning device 200 and the learning device 300 (step S103). For example, the output summation unit 353 adds the output of the decision tree trained in the current round to the output of the model up to the previous round by using the combination coefficient α that is a weight previously calculated based on the learning data held by the respective participants and is stored as the combination coefficient information 342. The output summation unit 353 may perform the weighted addition process for each class.

The conversion unit 354 performs a conversion process for expressing a probability for each class on the basis of a result of processing by the output summation unit 353. For example, the conversion unit 354 performs softmax conversion as shown by Expression 1, as a conversion process for expressing a probability (step S104).

The exemplary operation of the learning device 300 is as described above. The learning device 300 can repeat the series of processing as shown in FIG. 6 until a predetermined condition is satisfied, for example.

As described above, the learning device 300 includes the output summation unit 353 and the conversion unit 354. With this configuration, the learning device 300 can perform a conversion process for expressing a probability by the conversion unit 354 after the weighted addition process performed by the output summation unit 353. As a result, since the addition process is performed on the output of a decision tree that may take a negative value before performing softmax conversion, it is possible to make a correction in the next round when the probability is overestimated or the like. As a result, more precise learning can be performed. Moreover, when a positive value is added in each round, the ratio may exceed 1 as the round proceeds. However, according to the configuration described above, since the addition process is performed before the softmax conversion, the possibility that the probability exceeds 1 can be reduced.

In the present embodiment, description has been given on the case where a decision tree is used as a learner. However, a learner that is an object of the present invention is not limited to a decision tree. For example, a learner may be a shallow neural network or a support vector machine. Of course, a finally generated learner may be one corresponding to each of the learners described above. For example, in the case where a neural network is used as a learner, a finally generated model may be a gradient boosting neural network or the like.

### Second Example Embodiment

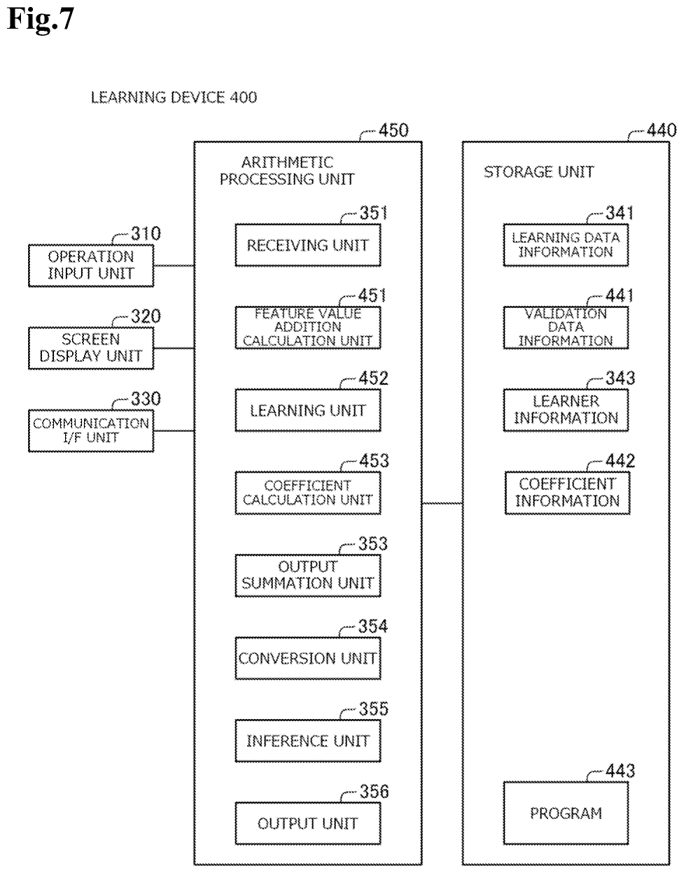

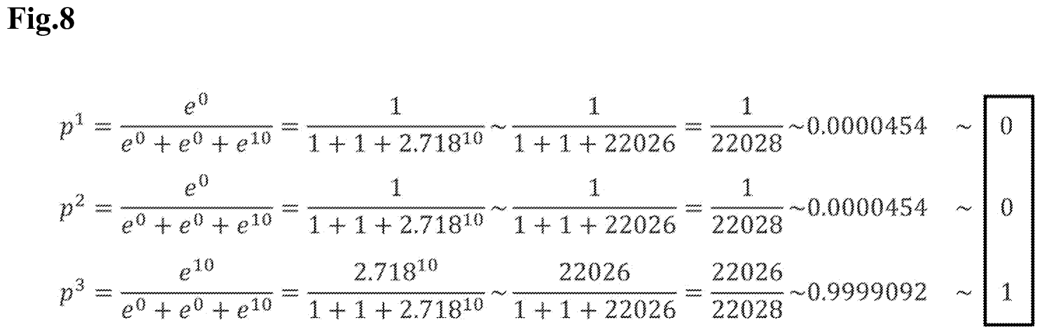

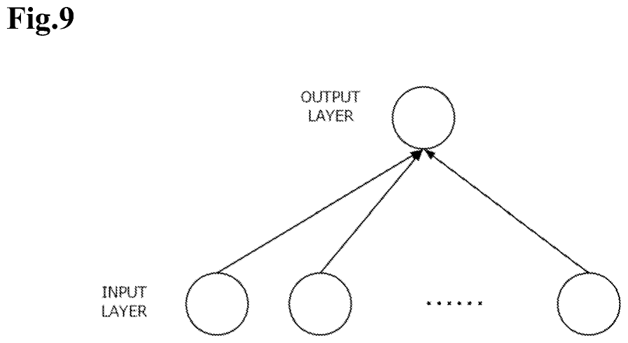

Next, a second example embodiment of the present disclosure will be described with reference to FIGS. 7 to 9. FIG. 7 is a block diagram illustrating an exemplary configuration of a learning device 400. FIG. 8 illustrates an example of softmax conversion. FIG. 9 illustrates an exemplary configuration of a neural network.

The second example embodiment of the present disclosure describes a modification of the learning system 100 described in the first example embodiment. The learning system 100 of the present embodiment can include a learning device 400 instead of the learning system 300 described in the first example embodiment or along with the learning device 300.

The learning device 400 is an information processing device that performs training of a decision tree that is more personalized than that of the learning device 300 described in the first example embodiment, in order to perform more appropriate prediction on data such as learning data held by the learning device 400 and validation data. For example, the learning device 400 calculates a combination coefficient α corresponding to each decision tree by using a decision tree trained by the own device, a decision tree received from another participant, previously stored validation data, and the like. Then, the learning device 400 performs processing to add up the calculated combination coefficients α. In other words, instead of setting the combination coefficient α based on the number of pieces of learning data, the learning device 400 calculates the combination coefficient α so as to allow the prediction capability with respect to the validation data to be optimum on the basis of a decision tree acquired from each participant and the validation data. Moreover, the learning device 400 trains the decision tree of the own device by performing training in which additional feature values, obtained by inputting learning data, validation data, and the like to the decision trees received from the other participants, are added to the learning data. By using any of the methods illustrated above or a combination thereof, the learning device 400 trains the decision tree that is further personalized to the learning data held by the own device.

Hereinafter, the learning device 400 that is a characteristic constituent element of the present embodiment, among the constituent elements included in the learning system 100, will be described.

FIG. 7 illustrates an exemplary configuration of the learning device 400. Referring to FIG. 7, the learning device 400 includes, for example, the operation input unit 310, the screen display unit 320, the communication OF unit 330, a storage unit 440, and an arithmetic processing unit 450, as main constituent elements. Note that the learning device 400 may be configured of a modification similar to the learning device 300 described in the first example embodiment. Moreover, the configurations of the operation input unit 310, the screen display unit 320, and the communication I/F unit 330 may be the same as those of the first example embodiment.

The storage unit 440 is a storage device such as a hard disk or a memory. The storage unit 440 stores therein processing information and a program 443 required for various types of processing performed in the arithmetic processing unit 450. The program 443 is read and executed by the arithmetic processing unit 450 to thereby implement various processing units. The program 443 is read in advance from an external device or a storage medium via a data input/output function of the communication I/F unit 330 or the like, and is stored in the storage unit 440. The main information stored in the storage unit 440 includes, for example, the learning data information 341, validation data information 441, the learner information 343, coefficient information 442, and the like. Note that the storage unit 440 may include the combination coefficient information 342 described in the first example embodiment and the like. Hereinafter, characteristic information in the present embodiment, among the pieces of information stored in the storage unit 440, will be described.

The validation data information 441 includes validation data that is data used for validating the performance of a trained decision tree. For example, the validation data information 441 is acquired in advance by using a method of acquiring it from an external device via the communication I/F unit 330, inputting it using the operation input unit 310, or the like, and is stored in the storage unit 440.

In the validation data information 441, a plurality of feature values and labels are associated with each other as similar to the learning data information 341. The validation data information 441 may include a plurality of pieces of validation data.

The coefficient information 442 includes a combination coefficient corresponding to each of the decision trees such as a decision tree received from the other learning device 200, a decision tree trained by the learning unit 452, and the like. For example, in the coefficient information 442, identification information of a decision tree and a combination coefficient are associate with each other. In the coefficient information 442, a combination coefficient for each round and for each decision tree may be included. For example, the coefficient information 442 is updated in response to calculation of a combination coefficient by a coefficient calculation unit 453 to be described below, or the like.

The arithmetic processing unit 450 includes an arithmetic unit such as a CPU and its peripheral circuits. The arithmetic processing unit 450 reads, from the storage unit 440, and executes the program 443 to implement various processing units through cooperation between the hardware and the program 443. Main processing units to be implemented by the arithmetic processing unit 450 include, for example, the receiving unit 351, a feature value addition calculation unit 451, a learning unit 452, a coefficient calculation unit 453, the output summation unit 353, the conversion unit 354, the inference unit 355, the output unit 356, and the like. Note that the arithmetic processing unit 450 may include a GPU or the like in place of the CPU, as similar to the first example embodiment. Hereinafter, characteristic constituent elements of the present embodiment will be described.

The feature value addition calculation unit 451 calculates additional learning data on the basis of the decision tree received by the receiving unit 351 and the learning data included in the learning data information 341. For example, the feature value addition calculation unit 451 acquires an output from a learner by inputting learning data included in the learning data information 341 to the decision tree received by the receiving unit 351. The feature value addition calculation unit 451 can acquire the output as an additional feature value.

For example, it is assumed that the learning data information 341 includes learning data (xᵢ, yᵢ) including a feature value xᵢ and a label yᵢ. It is also assumed that decision trees f₁( ), f₂( ) . . . are received from other learning devices 200. In that case, the feature value addition calculation unit 451 inputs the feature value xᵢ to each decision tree to calculate an additional feature value f₁(xᵢ), (f₂( ) . . . . As a result, the learning data to be learned by a learning unit 452 to be described below becomes (xᵢ, f₁(xᵢ), f₂(xᵢ) . . . , yᵢ).

Note that the feature value addition calculation unit 451 may calculate an additional feature value by using all decision tress received from the other learning device 200, or may extract some of the decision trees received from the other learning devices 200 and calculate an additional feature value by using the extracted some decision trees. The feature value addition calculation unit 451 may extract some of the decision trees by using any method. Moreover, the feature value addition calculation unit 451 may calculate an additional feature value by using every learning data included in the learning data information 341, or may extract part of it and calculate an additional feature value by using the extracted partial learning data. The feature value addition calculation unit 451 may extract part of the learning data by using any method, as similar to the above description. The feature value addition calculation unit 451 may calculate an additional feature value by inputting validation data to the decision tree instead of the learning data.

The learning unit 452 performs learning based on the feature value calculated by the feature value addition calculation unit 451 and the learning data represented by the learning data information 341 to train the decision tree that is a learner. The learning unit 452 may train a decision tree for each class as similar to the learning unit 352 described in the first example embodiment. For example, the learning unit 452 can train an additional decision tree so as to correct the error in the model up to the previous round by using a known method such as GBDT, as similar to the learning unit 352. The learning unit 452 may train a decision tree by using another known method. The learning unit 452 stores the generated decision tree in the storage unit 340 as the learner information 343.

The learning unit 452 may be configured to perform machine learning by adding an additional feature value calculated by the feature value addition calculation unit 451 as it is to the learning data, or perform machine learning by adding a result of linear combination applied to the additional feature value calculated by the feature value addition calculation unit 451, for example. The learning unit 452 may perform machine learning by adding, to the learning data, both the additional feature value calculated by the feature value addition calculation unit 451 and a result of linear combination applied to the additional feature value.

The coefficient calculation unit 453 calculates a combination coefficient for each decision tree by using validation data represented by the validation data information 441. For example, the coefficient calculation unit 453 calculates a combination coefficient such that the prediction performance with respect to the validation data represented by the validation data information 441 becomes optimum. The coefficient calculation unit 453 can calculate a combination coefficient for each decision tree received by the receiving unit 351 or each decision tree generated by the learning unit 452. The coefficient calculation unit 453 may perform the calculation by using a method such as linear regression such as multiple regression, neural network, support vector regression (SVR), or the like. Moreover, the coefficient calculation unit 453 stores the calculated combination coefficient in the storage unit 340 as coefficient information 442.

For example, it is assumed that the validation data information 441 includes validation data (x₁ᵢ, y₁ᵢ) including a feature value x₁ᵢ, and a label y₁ᵢ. It is also assumed that decision trees f₁₁( ), f₁₂( ), . . . are received or generated from the other learning device 200 or by the learning unit 452. In that case, first, the coefficient calculation unit 453 inputs validation data to each decision tree to obtain an output. For example, the coefficient calculation unit 453 inputs validation data(x₁ᵢ, y₁ᵢ) to the decision tree f₁₁( ) to obtain an output uᵢ. Further, the coefficient calculation unit 453 inputs validation data (x₁ᵢ, y₁ᵢ) to the decision tree f₁₂( ) to obtain an output vᵢ. Then, the coefficient calculation unit 453 uses (uᵢ, vᵢ, y₁ᵢ) to calculate a combination coefficient for each decision tree. For example, the coefficient calculation unit 453 may calculate a combination coefficient by performing linear regression or the like. For example, the coefficient calculation unit 453 may perform linear regression using the validation data (x₁ᵢ,y₁ᵢ) and the output uᵢ, to thereby determine a combination coefficient corresponding to the decision tree f₁₁( ).

When determining the combination coefficient, as a correct value of an output g, the coefficient calculation unit 453 may use a value that approximately approaches a correct label when softmax conversion is performed. For example, in the case where a probability of data belonging to class 3 of (0, 0, 1), (0, 0, 10) or the like may be used as the output g that is a correct value. For example, as illustrated in FIG. 8 that is a specific calculation example of Expression 2, by using (0, 0, 10) as a correct value of the output g, it is found that the value approximately approaches the correct label when softmax conversion is performed. Note that the correct value may be a value that approximately approaches the correct label other than that described above, such as (0, 0, 100).

Note that the coefficient calculation unit 453 may calculate a combination coefficient by using the entire validation data, or calculate a combination coefficient by using part of the validation data. For example, it is possible to specify a leaf node on which each validation data falls, by referring to model information for the decision tree generated by the learning unit 452 such as a model structure and split condition. Therefore, the coefficient calculation unit 453 may calculate a combination coefficient for each leaf node by performing linear regression or the like by using validation data for each leaf node, for example. Since the nature of falling data differs for each leaf node, by optimizing the combination coefficient for each leaf node, it is possible to realize optimization for each nature more precisely.

Moreover, the coefficient calculation unit 453 may calculate a combination coefficient by using learning data represented by the learning data information 341, instead of validation data. However, from the viewpoint of suppressing excessive deviation, it is preferable to calculate a combination coefficient by using validation data rather than using learning data.

The coefficient calculation unit 453 may calculate a combination coefficient by another arbitrary method as described above. For example, the coefficient calculation unit 453 may calculate a combination coefficient by means of regression using a neural network. As illustrated in FIG. 9, in the case of expressing linear regression by using a neural network, it can be described as a neural network structure having one layer without a hidden layer. For example, in the case illustrated in FIG. 9, the number units of the input layers depends on the number of participants, and the number of units of the output layers is one. This structure is expressed as Expression 3, for example. The coefficient calculation unit 453 can learn coefficients w₁, . . . w_{d} and bias b in Expression 3. In Expression 3, each of the coefficients w₁, . . . , w_{d} corresponds to the combination coefficient of each decision tree.

o₁=w₁x₁+w₂x₂+ . . . +w_{d}x_{d}+b [Expression 3]

Note that w represents a coefficient and corresponds to a combination coefficient of each decision tree. Further, x corresponds to an output of each decision tree.

In general, as illustrated in Expression 4, in the neural network, a non-linear activation function f is used. In the case of expressing linear regression as described above, by using an identity function as an activation function f, it can be expressed as shown in Expression 3. Note that the coefficient calculation unit 453 may used any activation function other than an identity function as an activation function f.

o₁=ƒ(w₁x₁+w₂x₂+ . . . +w_{d}x_{d}+b) [Expression 4]

Moreover, the coefficient calculation unit 453 may be configured to use a neural network having an intermediate layer to learn a parameter of the neural network, rather than that described above. In the case of such a structure, the number of intermediate layers may be any number, and the number of units is not limited particularly. Moreover, the coefficient calculation unit 453 may determine a combination coefficient by using SVR or the like. The coefficient calculation unit 453 may determine a combination coefficient by using any of the methods described above as examples.

In the present embodiment, the output summation unit 353 performs a weighted addition process by using a combination coefficient calculated and determined by the coefficient calculation unit 453, instead of a combination coefficient stored as the combination coefficient information 342. The subsequent processing may be similar to that of the first example embodiment.

As described above, the learning device 400 includes the feature value addition calculation unit 451 and the learning unit 452. With this configuration, the learning unit 452 can generate a decision tree that is a learner by performing learning using learning data to which a feature value calculated by the feature value addition calculation unit 451 is added. As a result, it is possible to generate a decision tree into which the result of learning by the other learning device 200 is also incorporated. Thereby, it is possible to generate a decision tree that is a learner more suitable to the data held by the own device while improving the performance. That is, according to the configuration described above, it is possible to perform more precise learning and perform more personalized training of a decision tree.

Further, the learning device 400 includes the coefficient calculation unit 453. With this configuration, the output summation unit 353 can perform a weighted addition process by using a combination coefficient calculated by the coefficient calculation unit 453. As described above, the coefficient calculation unit 453 calculates a combination coefficient such that the prediction performance with respect to validation data becomes optimum. Therefore, by combining the respective decision trees by using the combination coefficient, it is possible to generate a decision tree that is a learner that is more suitable for the learning device 300 having validation data. That is, according to the configuration described above, it is possible to perform more accurate learning and perform more personalized training of a decision tree.

In the present embodiment, the case where the learning device 400 includes both the feature value addition calculation unit 451 and the coefficient calculation unit 453 has been described as an example. However, the learning device 400 may include either the feature value addition calculation unit 451 or the coefficient calculation unit 453.

For example, in the case where the learning device 400 does not include the feature value addition calculation unit 451, the learning unit 452 performs training based on the learning data included in the learning data information 341 as similar to the learning unit 352 described in the first example embodiment. Even in that case, a combination coefficient is calculated such that the prediction performance with respect to validation data becomes optimum. Therefore, by combining each decision tree with use of the connection coefficient, it is possible to generate a decision tree that is a learner more suitable for the learning device 300 having the validation data.

Moreover, in the case where the learning device 400 does not include the coefficient calculation unit 453, the output summation unit 353 adds the output of a decision tree that is generated in the form of incorporating the learning result by the other learning device 200 and the output of the model up to the previous round. As a result, it is possible to generate a decision tree that is a learner more suitable to the data held by the own device while improving the performance.

### Third Example Embodiment

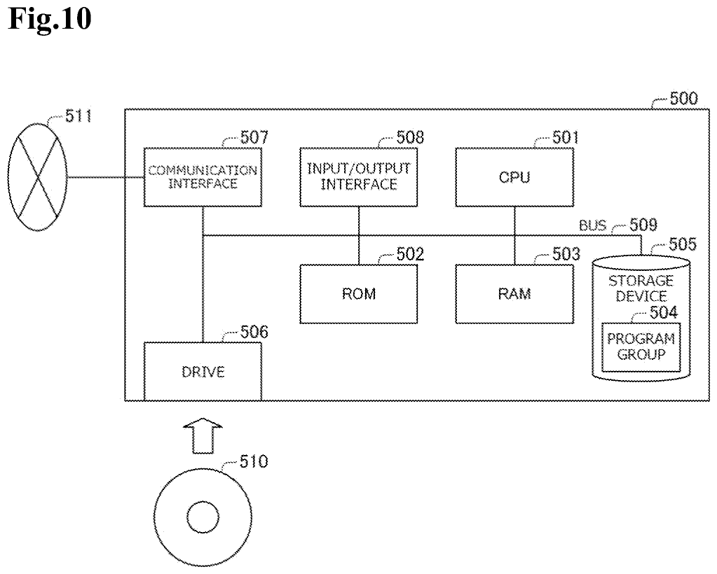

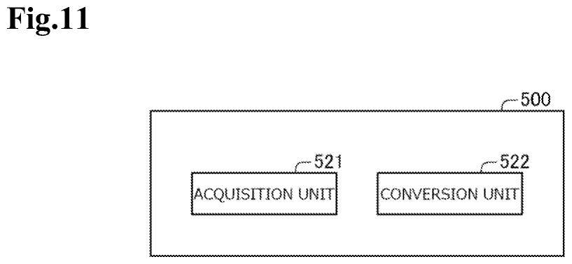

Next, a third example embodiment of the present disclosure will be described with reference to FIGS. 10 and 11. FIG. 10 is a diagram illustrating an exemplary hardware configuration of a learning device 500. FIG. 11 is a block diagram illustrating an exemplary configuration of the learning device 500.

In the third example embodiment, an exemplary configuration of the learning device 500 that is an information processing device that combines a learner received from another learning device and a learner trained by the own device will be described. FIG. 10 illustrates an exemplary hardware configuration of the learning device 500. Referring to FIG. 10, the learning device 500 has a hardware configuration as described below, as an example.
Central Processing Unit (CPU) 501 (arithmetic device)
Read Only Memory (ROM) 502 (storage device)
Random Access Memory (RAM) 503 (storage device)
Program group 504 to be loaded to the RAM 503
Storage device 505 storing therein the program group 504
Drive 506 that performs reading and writing on a storage medium 510 outside the information processing device
Communication interface 507 connecting to a communication network 511 outside the information processing device
Input/output interface 508 for performing input/output of data
Bus 509 connecting the respective constituent elements

Further, the learning device 500 can realize functions as the acquisition unit 521 and the conversion unit 522 illustrated in FIG. 11 through acquisition and execution of the program group 504 by the CPU 501. Note that the program group 504 is stored in the storage device 505 or the ROM 502 in advance for example, and is loaded to the RAM 503 or the like by the CPU 501 as needed. Further, the program group 504 may be provided to the CPU 501 via the communication network 511, or may be stored on the storage medium 510 in advance and read out by the drive 506 and supplied to the CPU 501.

FIG. 10 illustrates an exemplary hardware configuration of the learning device 500. The hardware configuration of the learning device 500 is not limited to that described above. For example, the learning device 500 may be configured of part of the configuration described above, such as without the drive 506.

The acquisition unit 521 inputs thereto, for each class, an output of a learner for each class received from another learning device and an output of a learner for each class trained by the own device, and acquires a given output for each class. For example, the acquisition unit 521 can acquire a given output by performing, for each class, a process of adding an output of a learner received from another learning device and an output of a learner trained by the own device with use of a combination coefficient.

The conversion unit 522 performs, for each class, a conversion process to express a probability with respect to the output acquired by the acquisition unit 521. For example, the conversion unit 522 may perform softmax conversion as a conversion process.

As described above, the learning device 500 includes the acquisition unit 521 and the conversion unit 522. With this configuration, the learning device 500 can perform a conversion process after the acquisition unit 521 acquired the output. As a result, since it is possible to perform a conversion process after the processing performed by the acquisition unit 521, correction can be made in the next round in the case where the probability is excessively evaluated or the like. As a result, more precise learning can be performed.

Note that the learning device 500 described above can be realized by incorporation of a predetermined program in an information processing device such as the learning device 500. Specifically, a program that is another aspect of the present invention is a program for realizing, on an information processing device such as the learning device 500, processing to input thereto an output of a learner received from another learning device and an output of a learner trained by the own device and acquire a given output, and perform a conversion process for expressing a probability with respect to the acquired output.

Further, a learning method to be executed by an information processing device such as the learning device 500 is a method including, by an information processing device such as the learning device 500, inputting thereto an output of a learner received from another learning device and an output of a learner trained by the own device and acquiring a given output, and performing a conversion process for expressing a probability with respect to the acquired output.

An invention of a program, a computer-readable storage medium storing thereon a program, or a learning method having the above-described configuration also exhibits the same actions and effects as those of the learning device 500. Therefore, the above-described object of the present disclosure can also be achieved by such an invention.

### SUPPLEMENTARY NOTES

The whole or part of the example embodiments disclosed above can be described as the following supplementary notes. Hereinafter, the outlines of the learning device and the like of the present invention will be described. However, the present invention is not limited to the configurations described below.

### (Supplementary Note 1)

A learning device comprising:
an acquisition unit that inputs thereto, for each class, an output of a learner for each class received from another learning device and an output of a learner for each class trained by an own device, and acquires a given output for each class; and
a conversion unit that performs, for each class, a conversion process to express a probability with respect to the output for each class acquired by the acquisition unit.

### (Supplementary Note 2)

The learning device according to supplementary note 1, wherein
the acquisition unit acquires the given output by performing, for each class, a process of adding the output of the learner received from the other learning device and the output of the learner trained by the own device with use of a given combination coefficient.

### (Supplementary Note 3)

The learning device according to supplementary note 2, wherein
the combination coefficient is a value determined in advance for each learning device on a basis of the number of learning datasets used for training of a learner by each learning device.

### (Supplementary Note 4)

The learning device according to supplementary note 2, further comprising
a calculation unit that calculates the combination coefficient on the basis of the learner received from the other learning device, the learner trained by the own device, and data held by the own device, wherein
the acquisition unit acquires the given output by performing, for each class, a process of adding the output of the learner received from the other learning device and the output of the learner trained by the own device with use of the combination coefficient calculated by the calculation unit.

### (Supplementary Note 5)

The learning device according to supplementary note 4, wherein
the calculation unit specifies data that falls to each leaf node in a decision tree that is a learner, and calculates the combination coefficient by using the data for each leaf node.

### (Supplementary Note 6)

The learning device according to supplementary note 4 or 5, wherein
the calculation unit calculates the combination coefficient on the basis of the learner received from the other learning device, the learner trained by the own device, and validation data that is data for validation and is held by the own device.

### (Supplementary Note 7)

The learning device according to any one of supplementary notes 1 to 6, further comprising:
a feature value calculation unit that calculate an additional feature value by using the learner received from the other learning device and data held by the own device; and
a learning unit that trains the learner by learning the feature value calculated by the feature value calculation unit in addition to the data held by the own device, wherein
the acquisition unit acquires the given output by performing, for each class, a process of adding the output of the learner received from the other learning device and the output of the learner trained by the own device with use of a given combination coefficient.

### (Supplementary Note 8)

The learning device according to any one of supplementary notes 1 to 7, wherein the conversion unit performs softmax conversion as the conversion process.

### (Supplementary Note 9)

A learning method comprising, by an information processing device:
inputting, for each class, an output of a learner for each class received from another learning device and an output of a learner for each class trained by the own device, and acquiring
a given output for each class; and performing, for each class, a conversion process to express a probability with respect to the acquired output for each class.

### (Supplementary Note 10)

A program for causing an information processing device to execute processing to:
input, for each class, an output of a learner for each class received from another learning device and an output of a learner for each class trained by the own device, and acquire a given output for each class; and
perform, for each class, a conversion process to express a probability with respect to the acquired output for each class.

While the present invention has been described with reference to the example embodiments described above, the present invention is not limited to the above-described embodiments. The form and details of the present invention can be changed within the scope of the present invention in various manners that can be understood by those skilled in the art.

### REFERENCE SIGNS LIST

100 learning system
200 another learning device
300 learning device
310 operation input unit
320 screen display unit
330 communication IN unit
340 storage unit
341 learning data information
342 combination coefficient information
343 learner information
344 program
350 arithmetic processing unit
351 receiving unit
352 learning unit
353 output summation unit
354 conversion unit
355 inference unit
356 output unit
400 learning device
440 storage unit
441 validation data information
442 coefficient information
443 program
450 arithmetic processing unit
451 feature value addition calculation unit
452 learning unit
453 coefficient calculation unit
500 learning device
501 CPU
502 ROM
503 RAM
504 program group
505 storage device
506 drive
507 communication interface
508 input/output interface
509 bus
510 storage medium
511 communication network
521 acquisition unit
522 conversion unit

1. A learning device comprising:
at least one memory configured to store instructions; and
at least one processor configured to execute instructions to:
input, for each class, an output of a learner for each class received from another learning device and an output of a learner for each class trained by an own device, and acquire a given output for each class; and
perform, for each class, a conversion process to express a probability with respect to the acquired given output for each class.

2. The learning device according to claim 1, wherein the at least one processor is configured to execute the instructions to
acquire the given output by performing, for each class, a process of adding the output of the learner received from the other learning device and the output of the learner trained by the own device with use of a given combination coefficient.

3. The learning device according to claim 2, wherein
the combination coefficient is a value determined in advance for each learning device on a basis of a number of learning datasets used for training of a learner by each learning device.

4. The learning device according to claim 2, wherein the at least one processor is configured to execute the instructions to:
calculate the combination coefficient on a basis of the learner received from the other learning device, the learner trained by the own device, and data held by the own device; and
acquire the given output by performing, for each class, a process of adding the output of the learner received from the other learning device and the output of the learner trained by the own device with use of the calculated combination coefficient.

5. The learning device according to claim 4, wherein the at least one processor is configured to execute the instructions to
specify data that falls to each leaf node in a decision tree that is a learner, and calculate the combination coefficient by using the data for each leaf node.

6. The learning device according to claim 4, wherein the at least one processor is configured to execute the instructions to
calculate the combination coefficient on a basis of the learner received from the other learning device, the learner trained by the own device, and validation data that is data for validation and is held by the own device.

7. The learning device according to claim 1, wherein the at least one processor is configured to execute the instructions to:
calculate an additional feature value by using the learner received from the other learning device and data held by the own device;
train the learner by learning the calculated feature value in addition to the data held by the own device; and
acquire the given output by performing, for each class, a process of adding the output of the learner received from the other learning device and the output of the learner trained by the own device with use of a given combination coefficient.

8. The learning device according to claim 1, wherein the at least one processor is configured to execute the instructions to
perform softmax conversion as the conversion process.

9. A learning method comprising, by an information processing device:
inputting, for each class, an output of a learner for each class received from another learning device and an output of a learner for each class trained by an own device, and acquiring a given output for each class; and
performing, for each class, a conversion process to express a probability with respect to the acquired given output for each class.

10. A non-transitory computer-readable medium storing thereon a program for causing an information processing device to execute processing to:
input, for each class, an output of a learner for each class received from another learning device and an output of a learner for each class trained by an own device, and acquire a given output for each class; and
perform, for each class, a conversion process to express a probability with respect to the acquired given output for each class.
